(19) United States
(12) Patent Application Publication
(10) Pub. No.: US 2012/0216395 A1
(43) Pub. Date: Aug. 30, 2012

(54) APPARATUS FOR MANUFACTURING A MULTILAYER TUBE FOR THE HYDRAULIC CONNECTION AND WIRING OF SOLAR PANELS

(76) Inventor: Francesco Tognon, Padova (IT)

(21) Appl. No.: 13/504,312

(22) PCT Filed: Oct. 26, 2010
(86) PCT No.: PCT/EP2010/066125

§ 371 Date: Apr. 26, 2012

(30) Foreign Application Priority Data
Oct. 28, 2009 (IT) PD2009A000314

(51) Int. Cl. F16L 31/00

(52) U.S. Cl. 29/700

(57) ABSTRACT

An apparatus for manufacturing a multilayer tube for the hydraulic connection and wiring of solar panels, comprising
elements for covering at least one flexible tube with at least one tape of thermally insulating material;
elements for tying said tape around the corresponding flexible tube;
elements for covering at least two tubes, which are already covered with the insulating tape and are arranged mutually side-by- side and parallel, with a protection and containment sheath;
elements for the longitudinal closure of the sheath.

### TECHNICAL FIELD

The present invention relates to an apparatus for manufacturing a multilayer tube for the hydraulic connection and wiring of solar panels.

### BACKGROUND ART

Currently, in order to install a solar panel of the thermal type, i.e., dedicated to the heating of a heat transfer fluid that is then designed to heat water for example for a home, one proceeds, after laying the panels, with the provision of the hydraulic and electrical connections.

The one or more fitted solar panels must be reached by a supply duct for the water to be heated and by a return duct for such water heated by passing through the one or more panels and, in the case for example of solar power systems with forced circulation, by an electrical connection for a probe for detecting the temperature of the water at the panel manifolds.

Such a complex installation is costly both in terms of time, since each duct and the wiring cable each require a dedicated path with a dedicated seat or chase or in any case must be laid each independently of the other, and in terms of space occupation, since according to currently applicable statutory provisions each duct for heat transfer fluids must be insulated thermally with layers of insulation which, in order to ensure the required performance, cause the individual duct to produce a diametrical space occupation of more than six centimeters.

In order to obviate the cited drawbacks of the background art, this same Applicant has devised a multilayer tube for the hydraulic connection and wiring of solar panels, which comprises
at least two tubes, one for supply and one for return, for a heat transfer fluid designed to circulate in at least one hydraulic panel with which the multilayer tube is associated, such tube being arranged along parallel paths,
at least one thermal insulation layer based on Aerogel, arranged so as to wrap around each tube,
a protection and containment sheath, arranged so as to surround all of such tubes with an Aerogel insulation layer, such sheath being shaped so as to form a longitudinal containment channel for at least one electrical wiring cable.

Such a multilayer tube allows to connect hydraulically one or more solar panels quickly and with very small space occupation, far lower than the space occupation required by known means.

Further, such multilayer tube is in compliance with statutory provisions, and in terms of performance and efficiency is not inferior to currently known thermally insulated tubes.

### Disclosure of the Invention

The aim of the present invention is to provide an apparatus for manufacturing a multilayer tube for the hydraulic connection and wiring of solar panels as described above.

Within this aim, an object of the invention is to provide an apparatus that can be managed easily with a small workforce.

Another object of the invention is to provide an apparatus that is flexible and easily adaptable to the production requirements of the user.

Another object of the invention is to propose an apparatus for manufacturing a multilayer tube for the hydraulic connection and wiring of solar panels that can be manufactured with known technologies.

This aim, as well as these and other objects that will become better apparent hereinafter, are achieved by an apparatus for manufacturing a multilayer tube for the hydraulic connection and wiring of solar panels, characterized in that it comprises
means for covering at least one flexible tube with at least one tape of thermally insulating material;
means for tying said tape made of thermally insulating material wrapped around the corresponding flexible tube;
means for covering two tubes, which are already covered with said insulating tape and are arranged mutually side-by-side and parallel, with a protection and containment sheath,
means for the longitudinal closure of said sheath.

### BRIEF DESCRIPTION OF THE DRAWINGS

Further characteristics and advantages of the invention will become better apparent from the following detailed description of two preferred but not exclusive embodiments of the apparatus according to the invention, illustrated by way of non-limiting example in the accompanying drawings, wherein:

FIG. 1 is a schematic plan view of an apparatus according to the invention in its first embodiment;

FIG. 2 is a schematic top view of a first part of the apparatus according to the invention;

FIG. 3 is a schematic side view of the first part of the apparatus of FIG. 2;

FIG. 4 is a schematic top view of a second part of the apparatus according to the invention;

FIG. 5 is a schematic side view of the second part of the apparatus of FIG. 4;

FIG. 6 is a transverse sectional view of a detail of the second part of the apparatus shown in FIGS. 4 to 6;

FIG. 7 is a schematic side view of a third part of the apparatus according to the invention;

FIG. 8 is a front view of the third part of the apparatus of FIG. 7;

FIG. 9 is a view of a detail of FIG. 8;

FIG. 10 is a top view of the third part shown schematically in FIG. 7;

FIG. 11 is a schematic side view of the first part of the apparatus according to the invention in a second embodiment thereof;

FIG. 12 is a front view of a detail of the first part of the apparatus in its second embodiment of FIG. 11;

FIG. 13 is a schematic top view of a portion of the apparatus according to the invention in its second embodiment.

### WAYS OF CARRYING OUT THE INVENTION

With reference to the figures, an apparatus for manufacturing a multilayer tube for the hydraulic connection and wiring of solar panels according to the invention is generally designated by the reference numeral 10 in its first embodiment.

The apparatus 10 comprises:
means 11 for covering two flexible tubes 12 and 13 each with a tape, 14 and 15 respectively, made of thermally insulating material;
means 16 for tying such tape made of thermally insulating material wrapped around the corresponding flexible tube;
means 17 for covering the two tubes covered with the insulating tape 14 and 15, such covered tubes being designated by the reference numerals 18 and 19 and being arranged mutually side-by-side and parallel, with a protection and containment sheath 20,
means 21 for the longitudinal closure of the sheath 20 on the covered tubes 18 and 19.

Downstream of the means 21 for the longitudinal closure of the sheath there are means 22 for the advancement of the finished multilayer tube 23, which are followed by coiling means 24. The apparatus 10 also comprises means 25 for cutting into tapes 26 of preset width thermally insulating material in roll form 27.

The material in roll form 27 is Aerogel.

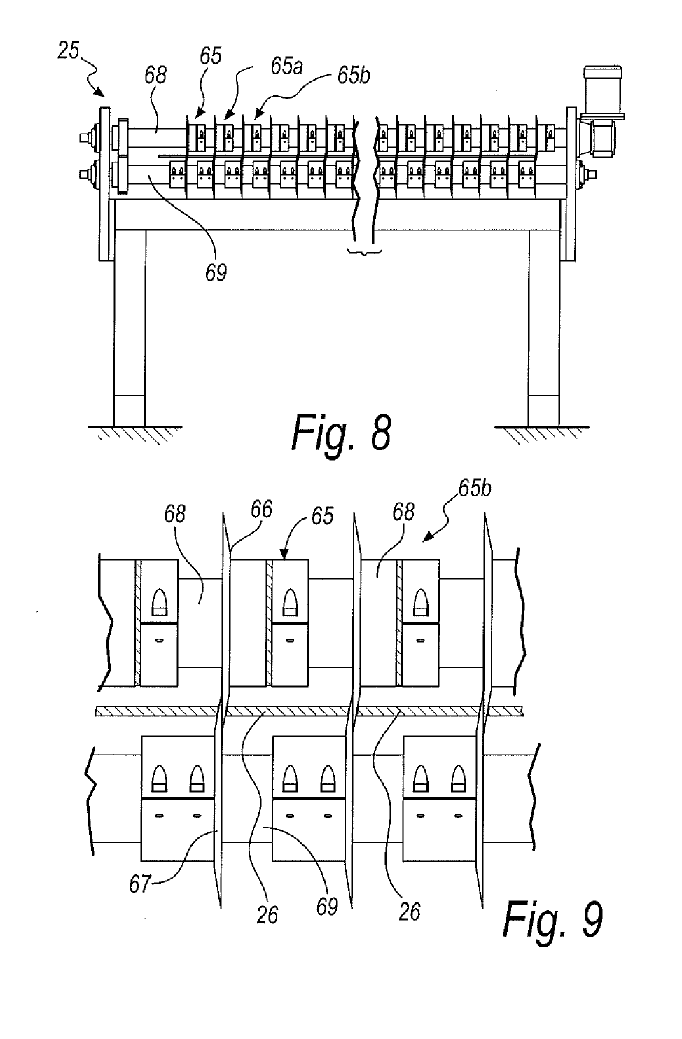

The means 11 for covering the two flexible tubes 12 and 13 receive the tapes 14 and 15 from corresponding rolls, for example 28 and 29, which are provided by way of the cutting means 25 of the Aerogel shown in FIGS. 7 to 10.

The flexible tubes 12 and 13 likewise arrive from corresponding spools 30 and 31.

The flexible tubes 12 and 13 are for example corrugated metallic tubes.

The means 11 for covering the two tubes 12 and 13 comprise two conical inlets 33 and 34, which are contoured to receive the tape 14 or 15 spread flat and to fold it during its advancement so as to wrap completely around the respective tube 12 or 13.

The tubes 12 and 13 wrapped in the respective tapes of Aerogel 14 and 15 exit from the conical inlets 33 and 34 in order to pass through the tying means 16, which are constituted for example by corresponding stranding devices 35 and 36, of a per se known type, each with one, two or four auxiliary strand carrying spools 37 and 38.

Both stranding devices 35 and 36 are actuated by a single electric motor 39, a sprocket which is keyed on the shaft of the motor 39, which acts on corresponding external sets of teeth of the rings that support the respective stranding devices.

The covered tubes 18 and 19 reach the means 17 for covering them with a protection and containment sheath 20 and are arranged mutually side-by-side and parallel.

At least one electrical cable is closed together with the two covered tubes 18 and 19 by the sheath 20 to the side of one of the two covered tubes.

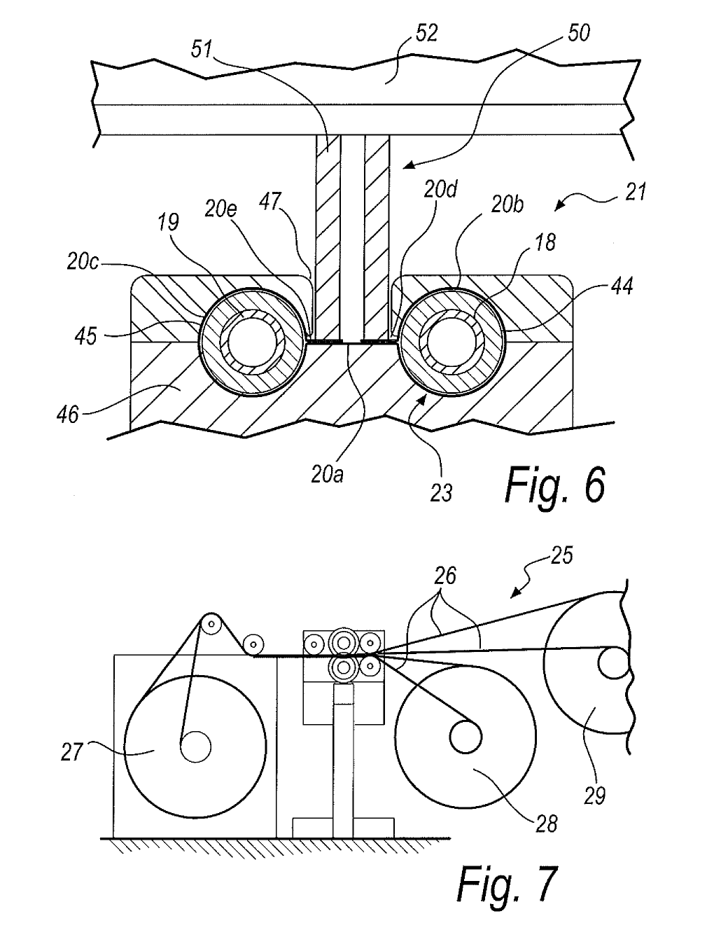

The covering means 17 comprise an inlet 40, which is designed to arrange a central region 20a of the tape of sheath 20 under the two tubes 18 and 19, while the lateral flaps 20b and 20c are raised, to be then folded, by a subsequent passage element 42 provided with two conical channels, in order to wrap around each one of the two tubes 18 and 19, until the edges 20d and 20e of the flaps are moved into contact with the upper face of the central region 20a, as shown in FIG. 6.

The means 21 for the longitudinal closure of the sheath 20 on the covered pipes 18 and 19 are shown schematically in cross-section in FIG. 6; the means 21 comprise a body 46 inside which two tubular channels 44 and 45 are formed for the passage of the covered tubes 18 and 19 wrapped in the sheath 20, and between the tubular channels 44 and 45 there is an open channel 47, by means of which the edges 20d and 20e of the sheath 20, which are superimposed on the central region 20a of the sheath 20, can be accessed from above by a heat-sealing device 50, which is designed to heat-seal the flaps 20d and 20e to the central region 20a of the sheath.

Such a heat-sealing device 50 is to be understood as being of a per se known type, for example having a hot presser 51 moved by a press 52.

The means 22 for the advancement of the finished multilayer tube 23 are of the stepwise type.

The stepwise advancement means 22 comprise locking jaws 54 designed to grip the finished multilayer tube 23 to then perform a translational motion on rails 56 for the advancement of the finished multilayer tube by actuators 55.

The translational motion of the jaws 54 is synchronized with the movements of the press 52, so that the advancement of the finished multilayer tube 23 occurs when the presser 51 is lifted.

Downstream of the advancement means 22 there are the coiling means 24, which comprise, in addition to a motorized reel 58 onto which the multilayer tube 23 is to be wound, means 60 for diverting the multilayer tube 23 which are adapted, to direct the multilayer tube 23 so as to optimize winding onto the reel 58.

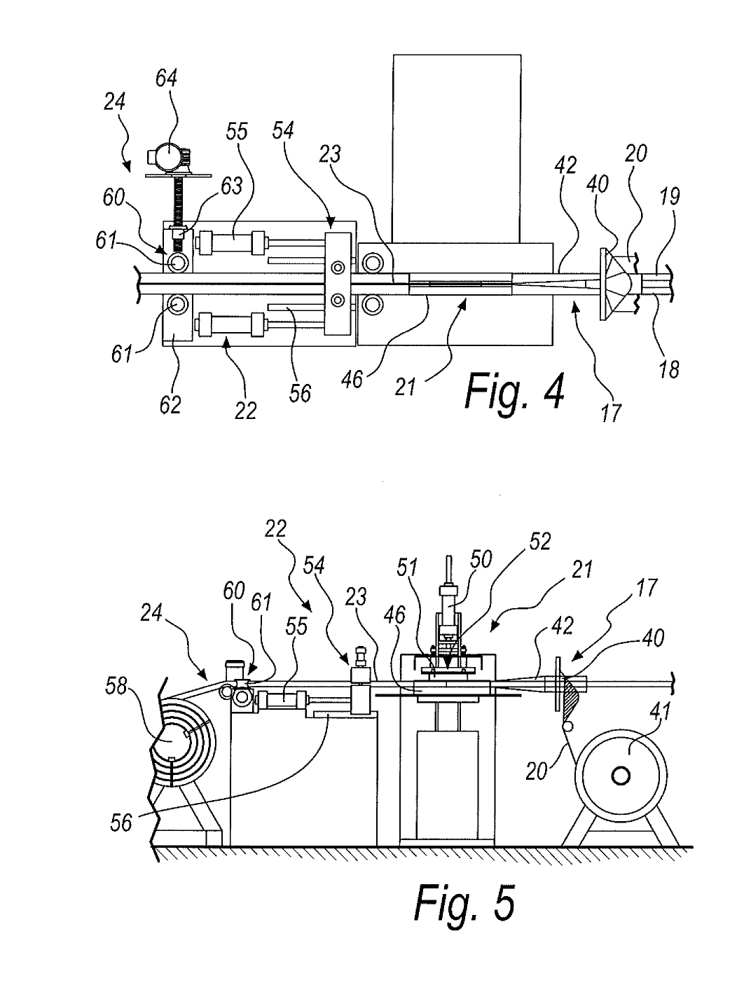

The diverting means 60 comprise a pair of mutually opposite pulleys 61, between which the finished multilayer tube 23 passes; such pulleys are supported by a support 62 designed to be translated to the right and to the left alternately by lead screw and worm screw means 63 of a per se known type, which are managed by an electric motor 64, as shown by way of example in FIGS. 4 and 5.

The means 25 for cutting into tapes 26 of preset width the Aerogel in roll form 27, shown in FIGS. 7 to 10, are constituted by a series of side-by-side pairs of rotating circular blades 65, 65a, 65b and so forth.

Each pair of blades, for example 65a, comprises two circular blades 66 and 67, each keyed on a corresponding driving shaft 68 and 69 of two drive shafts with parallel axes.

The blades 66 and 67 of each pair have superimposed cutting edges so that the quality of the cut is the same for all the edges of all the tapes 14 that are provided.

The blades 66 and 67 are supported by collars 68 that can be opened to reposition the blades on the respective driving shafts, so as to allow to adjust the width of the tapes 26 to be provided.

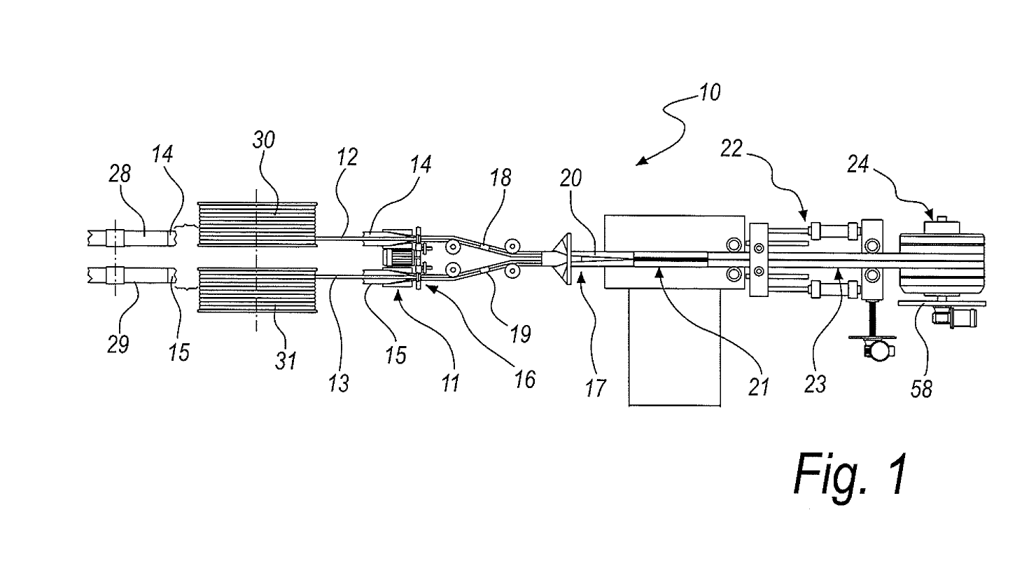

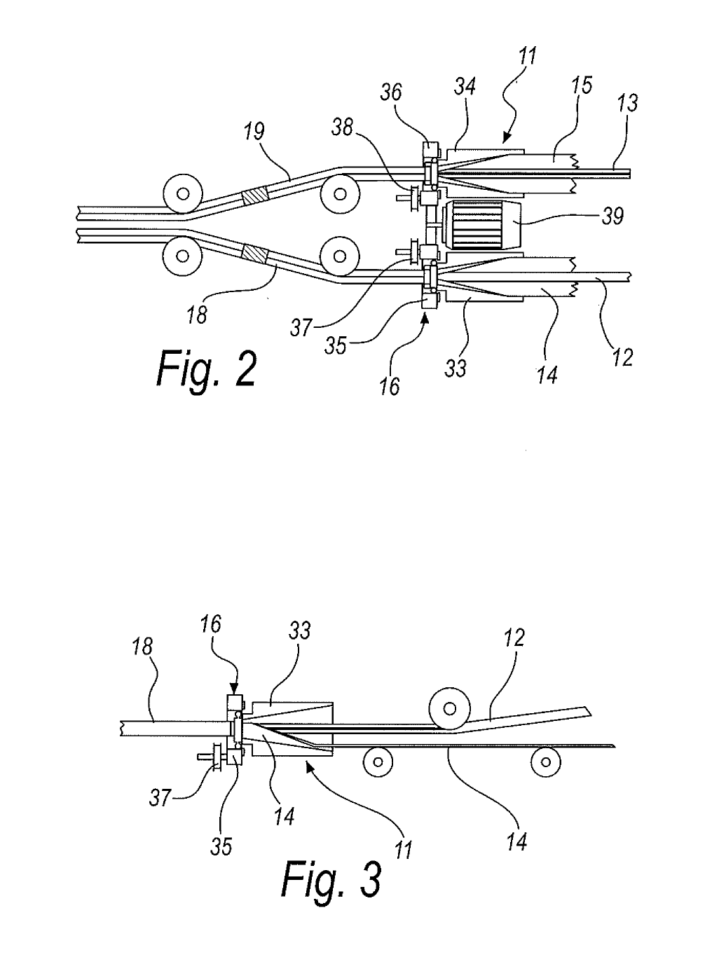

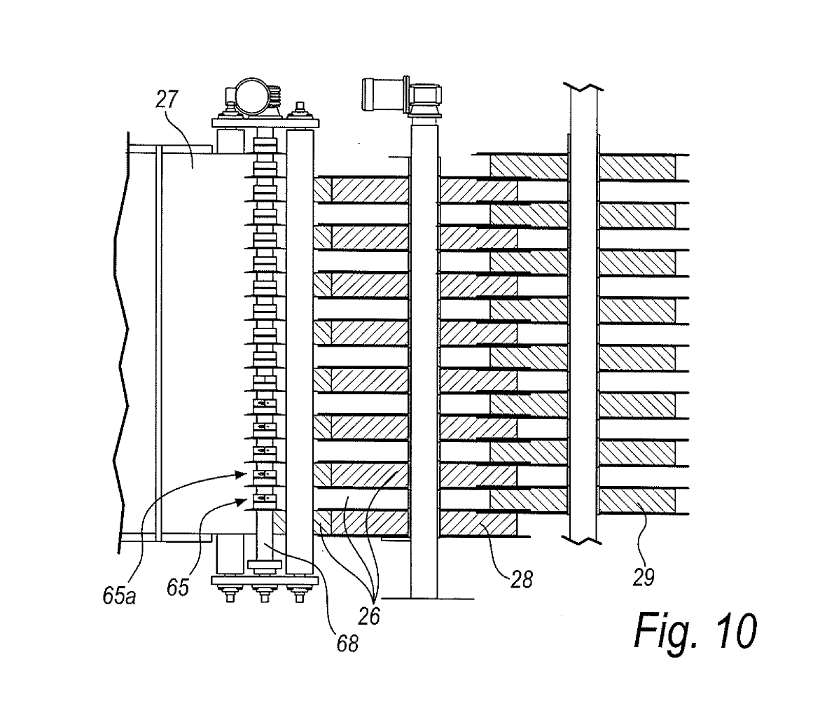

FIG. 10 shows that the various tapes 26 are gathered in rolls 28 and 29, which are then arranged, as shown in FIG. 1, in input to the covering means 11.

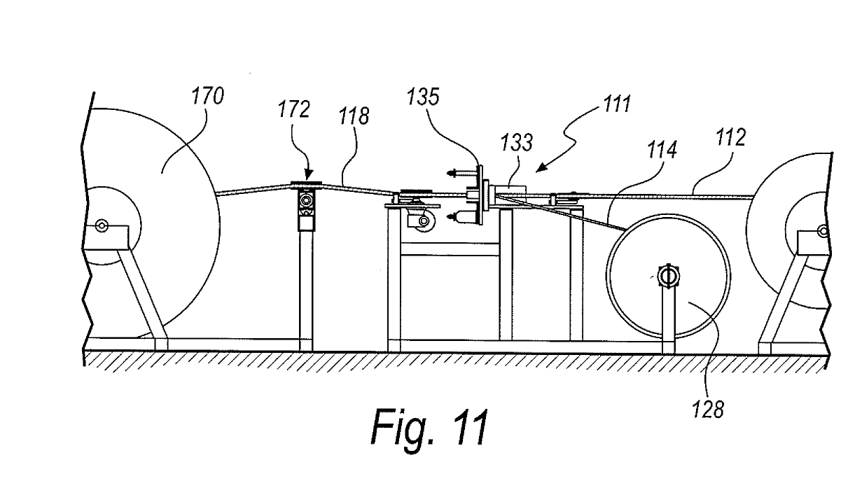

In a second embodiment of the apparatus according to the invention, the means 111 for covering two flexible tubes 112 and 113, shown schematically in FIG. 11, receive a tape 114 of Aerogel from a roll 128, provided by way of the means 25 for cutting the Aerogel described above.

The means 111 process a single flexible tube 112 instead of two as in the first embodiment of the apparatus.

The means 111 for covering the tube 112 comprise a conical inlet 133 and a stranding device 135 of a per se known type and as described above.

The covered tube 118 is directed to a spool 170.

The apparatus 110 in its second embodiment, exemplified in FIG. 13, has in input to the means 117 for covering with a sheath 120 two spools 170 and 170a of covered tube 118, instead of two paired covering devices 11 and tying means 35 as in the first embodiment of the apparatus.

The rest of the apparatus 110 in its second embodiment corresponds to what has been described for the first embodiment of the apparatus 10.

Advantageously, means 172 for diverting the covered tube 118 are associated with the spool 170 and are adapted to direct such tube so as to optimize the winding of the spool 170.

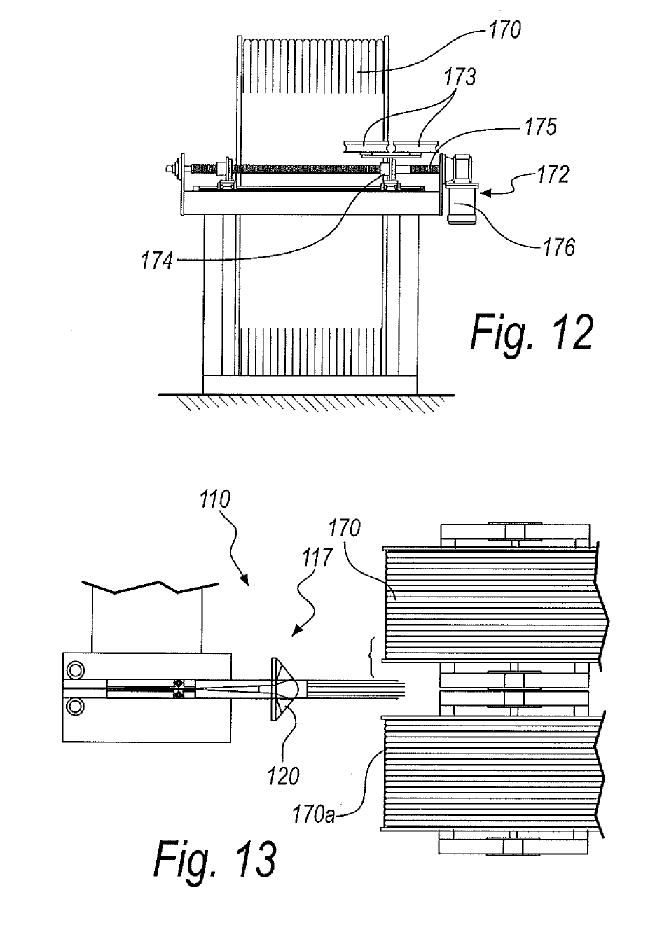

The diverting means 172 comprise a pair of mutually opposite pulleys 173, between which the finished multilayer tube 23 passes, such pulleys being supported by a support 174 designed to be translated to the right and to the left alternately by lead screw and worm screw means 175, of a per se known type, which are managed by an electric motor 176, as exemplified in FIG. 12.

In practice it has been found that the invention achieves the intended aim and objects.

In particular, the invention provides an apparatus for manufacturing a multilayer tube for the hydraulic connection and wiring of solar panels as described in the introduction to the present description.

Further, the invention provides an apparatus that can be managed easily with a small workforce, since all the parts of the apparatus can be substantially automated, except in the second embodiment, in which a conveyance of spools of covered tube occurs.

Moreover, the invention provides an apparatus that is flexible and easily adaptable to the production requirements of the user, since it is possible to vary the type and size of the flexible tubes and the width of the tapes of Aerogel according to the requirements and needs.

Not least, the invention provides an apparatus for manufacturing a multilayer tube for the hydraulic connection and wiring of solar panels that can be manufactured with per se known technologies.

The invention thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. PD2009A000314 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-10. (canceled)

11. An apparatus for manufacturing a multilayer tube for the hydraulic connection and wiring of solar panels, comprising
means for covering at least one flexible tube with at least one tape of thermally insulating material;
means for tying said tape made of thermally insulating material wrapped around the corresponding flexible tube;
means for covering at least two tubes, which are already covered with said insulating tape and are arranged mutually side-by-side and parallel, with a protection and containment sheath,
means for the longitudinal closure of said sheath.

12. The apparatus according to claim 11, further comprising means for cutting into tapes of preset width thermally insulating material in roll form.

13. The apparatus according to claim 11, wherein downstream of said means for longitudinal closure of the sheath there are means for the advancement of a finished multilayer tube, which are followed by means for coiling the finished multilayer tube.

14. The apparatus according to claim 12, wherein said thermally insulating material in roll form is Aerogel.

15. The apparatus according to claim 12, wherein said means for covering at least one flexible tube comprise two conical inlets, which are contoured to receive the tape spread flat and to fold it during its advancement so as to wrap completely around the respective tube.

16. The apparatus according to claim 11, wherein said tying means comprise stranding means which are actuated by a single electric motor.

17. The apparatus according to claim 11, wherein said covering means comprise an inlet designed to arrange a central region of the sheath tape below the two covered tubes, while lateral flaps of the sheath tape are lifted, to be then folded, by a successive passage element provided with two conical channels, in order to wrap around each one of the two tubes until edges of the flaps are moved into contact with the upper face of the central region of said sheath, at least one electrical cable being optionally enclosed by the sheath, laterally to one of the two covered tubes, together with said two covered tubes.

18. The apparatus according to claim 17, wherein said means for the longitudinal closure of said sheath on said covered tubes comprise a body inside which two tubular channels are formed for the passage of the covered tubes wrapped in the sheath, and in that between said tubular channels there is an open channel, by means of which the edges of the sheath, which are superimposed on the central region of said sheath, are accessible by a heat-sealing device, which is designed to heat-seal the flaps to the central region of the sheath.

19. The apparatus according to claim 13, wherein said means for the advancement of the finished multilayer tube are of the stepwise type and comprise locking jaws designed to grip the finished multilayer tube, to then perform a translational motion on rails for the advancement of the finished multilayer tube by actuators.

20. The apparatus according to claim 14, wherein said means for cutting into tapes of preset width the Aerogel in roll form comprise a series of side-by-side pairs of rotating circular blades, each pair of blades comprising two circular blades, each keyed on a corresponding driving shaft of two motor shafts with parallel axes, said blades of each pair having superimposed cutting edges.
